(19) United States
(12) Patent Application Publication
(10) Pub. No.: US 2024/0405556 A1
(43) Pub. Date: Dec. 5, 2024

(54) COORDINATION AND CONTROL OF CONTROLLABLE ENERGY RESOURCES IN AN ELECTRIC NETWORK TO MAINTAIN CONTINUOUS SUPPLY AND DEMAND BALANCE

(71) Applicant: PXiSE Energy Solutions, LLC, San Diego, CA (US)

(72) Inventors: Charles H. Wells, San Diego, CA (US); Raymond A. de Callafon, San Diego, CA (US); Patrick T. Lee, San Diego, CA (US)

(21) Appl. No.: 18/627,284

(22) Filed: Apr. 4, 2024

Related U.S. Application Data
(60) Provisional application No. 63/471,201, filed on Jun. 5, 2023.
(60) Provisional application No. 63/471,204, filed on Jun. 5, 2023.

(51) Int. Cl. H02J 3/28; H02J 3/24

(52) U.S. Cl. CPC H02J 3/28; H02J 3/24

(57) ABSTRACT

To enable reliable transition of an electric grid towards a low or no inertia state, implementations provide a system and/or a method to control the flow of real and reactive power in an electric grid that includes a heterogenous mix of distributed energy resources (DERs). The control of the flow of real and reactive power is to maintain continuous balance between electric supply and demand in an alternating current (AC) electric network. The heterogeneous mix of DERs can include multiple DERs, two or more of which are different types relative to one another. Types of DERs can include, for example, dispatchable thermal generators, renewable energy resources, and/or battery energy storage systems with inverters. Moreover, one or more of the DERs and their inverters can be configured to operate as either a voltage source (Grid Forming, GFM) or a current source (Grid Following, GFL) inside the AC electric network.

### BACKGROUND

In practice today, when trying to maintain a continuous balance between electric supply and demand in an AC electric network, one relies on the assumption or availability of so-called high rotational inertia or slow-reacting behavior of the rotating machinery of grid-forming (GFM) resources in the AC electric network. The slow-reacting behavior of the rotating machinery of GFM resources ensures that an AC frequency deviation becomes visible when electric supply and demand are mismatched. The assumption of high inertia of GFM resources is valid if these resources can be characterized as the rotating machinery of Generator Based Resources (GBRs). Unfortunately, this assumption becomes invalid in a small AC electric network such as a disconnected microgrid or an AC electric grid on an isolated island or remote community when Inverter Based Resources (IBRs) are used. For such small AC electric networks, typically only one GFM resource or IBR is used. In some instances, multiple GFM inverters or IBRs are used, but this approach requires tightly coupled and synchronized AC frequencies of the multiple GFM inverters to avoid undesirable power flow surges between IBRs.

The practice of using a single GFM or multiple tightly coupled and synchronized GFMs in a small AC power network is necessary to avoid uncontrollable AC power flow fluctuations between the so-called low inertia or fast-acting GFM inverters when individual AC frequencies of the GFM inverter are not synchronized in their voltage amplitude and voltage frequency. Although a single GFM would suffice in a small AC electric network, multiple GFM resources are often desired for resiliency as at least one operating GFM is required to form the AC voltage with its main AC frequency in an AC electric network.

For large AC electric networks, the asynchronous behavior of multiple GFM resources is solved by relying on the actual large inertia of slow-acting GFM resources, such as GBRs. Furthermore, AC power production of the GFM resource is controlled by observing the AC frequency in the power grid and adjusting power production via a frequency droop algorithm, where power production is adjusted proportionally with respect to change or “droop” of the AC frequency. Such a solution can also be extended by simulating a large inertia or slow-acting GFM inverters in a small AC network, but will not exploit the favorable control capabilities of fast-acting GFM inverters to maintain a continuous balance between electric supply and demand in a small or isolated AC electric network subjected to highly volatile power production from renewable energy resources. This is especially the case when the small AC network has IBRs, where frequency may not change due to an imbalance in electric supply and demand, and control of power flow based on measurements of frequency deviations becomes infeasible.

### SUMMARY

To enable reliable transition of an electric grid towards a low or no inertia state, implementations disclosed herein provide a system and/or a method to control the flow of real and reactive power in an electric grid that includes a heterogenous mix of distributed energy resources (DERs). The control of the flow of real and reactive power is to maintain continuous balance between electric supply and demand in an alternating current (AC) electric network. The heterogeneous mix of DERs can include multiple DERs, two or more of which are different types relative to one another. Types of DERs can include, for example, dispatchable thermal generators, renewable energy resources, and/or battery energy storage systems with inverters. Moreover, one or more of the DERs and their inverters can be configured to operate as either a voltage source (Grid Forming, GFM) or a current source (Grid Following, GFL) inside the AC electric network.

Implementations disclosed herein can be utilized for standalone microgrids including islands and remote communities. Implementations disclosed herein can additionally or alternatively be utilized for a large regional power grid when it is considered as a large microgrid or organized as a network of interconnected microgrids. As used herein, a microgrid can follow the definition provided by the Department of Energy (DOE). More particularly, a microgrid, as used herein, is a group of interconnected loads and distributed energy resources within clearly defined electric boundaries that acts as a single controllable entity with respect to the grid. A networked microgrid can connect and disconnect from a regional grid to enable it to operate in both grid-connected mode or in island mode. This definition applies to any controllable load or power source in a power network.

Implementations disclosed herein relate to control of multiple fast-acting GFM DERs in any AC electric network, with or without other additional GFM and/or GFL DERs to operate and coordinate power flow in/out of each of the controllable DERs, to maintain a continuous balance between electric supply and demand without causing undesired power flow fluctuations between the GFM DERs and while providing redundant voltage sources for the AC electric network. Operating multiple fast-acting GFM DERs in a small AC electric network, such as a microgrid, provides a higher level of voltage source reliability. In addition, the control of fast-acting GFM DERs that allow for energy storage, such as BESS DERs, enables a higher percentage of renewable energy penetration in the AC electric network, while maintaining a balance between electric supply and demand.

To provide for integration in a network with multiple inverters that can be configured as GFM and GFL resources and to coordinate with other conventional generators, implementations disclosed herein add a real and reactive power control loop to each GFM inverter for supervisory control. Some of those implementations of the supervisory control loop utilize fast and time-synchronized, two-input and two-output, decoupling feedback control of real and reactive power. The decoupling feedback control uses measurements of real and reactive power produced by a GFM inverter to modulate the voltage magnitude and voltage frequency setpoints to the GFM inverter, which in turn influences the real and reactive power produced by the GFM inverter. The decoupling feedback control also optionally includes setpoint feedforward components and compensation for possible time delay in the feedback system. Implementations disclosed herein also set forth how additional layers of control components support grid connected microgrids such as local area grids in a large regional grid and that can import, export, and rapidly control power flow to and from the connected microgrids.

As used herein, a regional grid includes central generation resources, transmission and distribution networks, locally distributed energy resources, and end-use electricity consumers covering one or more States, Cities, or other municipality in a large geographic area. As used herein, a local area grid is a portion of a regional grid and includes generation resources, distribution networks, local distributed energy resources, and end-user electricity consumers covering a local area. As used herein, an isolated microgrid is a microgrid that has no connection to a local area grid or to a regional grid. An isolated microgrid can be, for example, an island power grid or a remote community power grid. As used herein, a networked microgrid is connected to a local area grid or to a regional grid, and can be operated in connected microgrid mode, can be operated in disconnected microgrid mode, can transition seamlessly from disconnected to connected mode, and can transition seamlessly from connected to disconnected mode. As used herein, a voltage phasor includes voltage angle (A) and voltage magnitude (V) measurements of the sinusoidal voltage waveform in an AC power network. The voltage angle measurement can be relative to a synthetic voltage angle of zero at the top of the global positioning satellite (GPS) second. As used herein, the Point of Interconnection (POI) of a microgrid can be represented by one or more measurement points. As used herein, controllable energy resources include generator-based resources (GBR), inverter-based resources (IBR), and controllable loads. As used herein, grid forming (GFM) inverters operate as voltage sources and can accept external voltage magnitude (V) and voltage frequency (F) setpoints. As used herein, grid following (GFL) inverters operate as current sources and can accept external real power (P) and reactive power (Q) setpoints. As used herein, system inertia is defined as the electric frequency sensitivity of an electric grid formed by spinning generators. The frequency varies because of a sudden change in mismatch of supply and demand. For example, the system inertia of an island can be represented as −0.1 Hz variation per 3 MW of supply shortfall. As another example, for large regional grids, the system inertia can be represented as 0.1 Hz per 1000 MW of real power variation.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts an example child controller controlling an example energy storage unit based on inputs from an example parent controller.

FIG. 2 depicts an example configuration of a microgrid controller with multiple GFM inverters in an isolated electric grid.

FIG. 3 depicts an example of implementations for controlling a heterogenous mix of distributed energy resources (DERs) in a regional grid, to provide redundant voltage sources and maintain a net power flow target.

FIG. 4 depicts an example of implementations for controlling power flow in a large regional grid, that includes networked local area microgrids and facility microgrids.

### DETAILED DESCRIPTION

Prior to turning to the figures, a non-limiting overview of various implementations is provided.

The electric power grid is undergoing a profound change due to the need to rapidly replace traditional and dispatchable fossil fired generators with variable renewable supply resources. For over one hundred years, fossil-based thermal generators with significant spinning inertia have been supplying electricity to the grid and providing a common electric frequency signal to coordinate system operations. For the last hundred or more years, the electric transmission and distribution networks have been delivering electricity to consumers in a manner similar to how water flows due to gravity. That is, with no control of the loads the direction of flow has always been toward the loads. The amount of flow is related to the electrical impedance or resistance to flow caused by the wires and the load. For example, if the electrical impedance or resistance is low, more power will flow in that direction. The power network was designed to distribute power evenly in three phases from a balanced phase high voltage distribution network operating at 12 kV or higher voltage. Power flows, according to network impedances, from the “top” of the grid and without any active flow control of the power towards loads. These systems rely on large synchronous generators to supply power to the grid to meet demand and to provide rotating mass providing inertia to stabilize the grid. Multiple generators are normally employed and are generally dispatched economically to supply the power as required by the load demand.

The electric power frequency or Alternating Current (AC) frequency in an AC power system with spinning inertia is used as an indicator for supply and demand balance. A nominal electric frequency of 50 Hertz or 60 Hertz in an electric grid represents supply and demand is in balance. Traditionally, when electric frequency suddenly decreases, it is associated with a load increase, a generator output loss, or more generally a situation where the demand is greater than the supply. The balance of the power system is controlled by automatic generation control (AGC) of designated generators using frequency as the indication of imbalance and by calling on additional generation at higher output levels or by reducing load in real-time to restore frequency to its nominal value. This traditional AGC approach will take minutes to restore a nominal electric frequency of 50 Hertz or 60 Hertz by the action of many independently controlled generators to make up a large supply and demand difference often when one or more generators are tripped offline.

The AGC approach works in an electric grid with a significant spinning inertia where each designated generator is programmed with droop controls to respond to a deviation from the nominal frequency independently from the control action of other generators. For example, a generator with a 3% droop setting will maximize its power output if the nominal frequency has dropped 3% or more. Since each generator with AGC has its only pre-determined response, such system works when the rate of change of frequency is slow, avoiding collision of independent action from the slow fossil-based generators. In a grid formed by spinning fossil-based generators, the sudden imbalance between the supply and demand will result in a proportional electric frequency deviation. As more spinning generation is retired, there is less spinning grid inertia, causing the rate and magnitude of frequency deviation to increase proportionally. In other words, as spinning generation is retired the grid becomes more sensitive to supply demand imbalance and less stable than before. It has been observed in many isolated grids that the number of Under Frequency Load Shed (UFLS) events have increased due to more rapid and deeper frequency drop when a large generator trips offline. UFLS is designed to reduce load quickly by opening circuit breakers to save the grid from a system blackout. This is a major problem in isolated systems that rely exclusively on fossil-based generation. As more renewable generation is added, grids become weaker due to inertia loss and more frequent variation of renewable supplies. Such grid conditions will continue to get worse as more renewable generation is added to the grid while conventional spinning generation is retired.

In electric grids with low inertia or no inertia (no spinning generation), the frequency droop method of AGC control with slow response and poor coordination will lead to more occurrences of supply-demand imbalance and power grid failures. One solution has been proposed by the industry to add “synthetic” inertia to inverters (to mimic the AGC approach) by utilizing droop controls on each inverter-based resource (IBR) to respond to the electric frequency deviation. Such a method of applying AGC concept to an IBR, thereby attempting to mimic a generator, has limited success in a grid with large system inertia. Moreover, it can make the situation worse when these inverters with synthetic inertia cannot coordinate as a system to respond to fast events occurring on the power grid, therefore resulting in more UFLS events. With more frequent and sudden variation of renewable generation resources and a more frequency sensitive electric grid due to low spinning inertia, larger frequency excursions are expected. Accordingly, the traditional AGC approach is inadequate to maintain the grid reliability accustomed by consumers. More specifically, the AGC approach that relies on frequency as the primary control signal will not work in a grid with all IBR supplying the network and in which supply-demand imbalance does not result in a proportional frequency deviation.

Implementations disclosed herein provide a system and/or method to control the power grid with or without system inertia. The implementations are applicable to any electric grid with a mix of GBR and IBR generation, including grids with all IBR generation where multiple GFM inverters provide redundancy to form the grid and are coordinated with other available GFL generation resource. This approach does not utilize synthetic inertia in IBR that behaves like a generator.

An increasing number of electric grids today have been integrated with a considerable number of distributed renewable sources and electric vehicles (EV) which are affecting the daily power flow and directions in an electric distribution network. Existing electric distribution management systems are not designed to optimally dispatch these distributed resources and are not designed to handle multi-directional power flow. Many of these distributed IBR will also cause voltage and current flow disturbances when their power outputs are not being anticipated and controlled. The approach of using synthetic inertia in these smaller distributed IBR will be even more difficult and ineffective. Implementations disclosed herein describe how to operate one or more GFM inverters inside a power grid organized as a single network or as networked microgrids interconnected within a Power Utility network. The microgrids can be operated either as connected or as disconnected microgrids. Implementations are additionally or alternatively applicable to permanently isolated microgrids typically located in remote areas or on real islands.

Traditionally, GFM inverters are not deployed and operated in parallel since they cause fluctuations in power flows between the GFM units due to minor changes in the inverter PLL tuning constants and instrument measurement accuracy and noise.

Implementations disclosed herein describe how to control voltage and current in an electric grid organized as a single microgrid concept or as a network of interconnected microgrids using GFM inverter technology as the primary voltage sources to form the grid and optionally integrate with a mix of conventional generators and grid following inverters (GFL): (typically rooftop PV and EV) and controllable loads. This approach does not require changes to the existing distribution power network. Implementations apply to operation in connected mode and disconnected mode of networked microgrids.

Most inverters operate in grid following mode (GFL) since they commonly follow the grid voltage and frequency provided by large fossil generators or a local generator. Such network arrangement provides a strong voltage and frequency waveform signal for the inverters so that they can follow and inject power along the same voltage waveform. However, when operating in an isolated grid or in a networked microgrid in disconnected mode, a master voltage and frequency source is required to form the grid. This is commonly supplied by a grid forming inverter (GFM) or by a local fossil-based generator. However, in disconnected microgrids operating on 100 percent renewable energy, there is no fossil generator to form the grid. Fossil generators will only be needed when there is no wind, solar, or other renewable power available for an extended period. In implementations disclosed herein, fossil generators are activated only when necessary and run at their optimal rate. In some of those implementations, with IBR for practical integration with existing GBR, the generators are only operated in grid following mode with multiple GFMs providing the voltage sources to form a reliable grid.

GFM inverters accept voltage magnitude (V) and voltage frequency (F) setpoints, collectively called (VF) setpoints. The resulting output is in the form of alternating current, producing real power (P) and reactive power Q), collective called (PQ) output, necessary to hold the requested VF setpoints. The power input to the inverter is from a direct current (DC) source such as a battery or photovoltaic solar panels, or from back-to-back inverters in a wind turbine. The traditional use of voltage source inverters is to maintain voltage and frequency in an isolated microgrid configuration and as “networked” microgrid applications that are operating in “disconnected” mode. GFM inverters are also used extensively in operating large electrical equipment in the process industry in the form of variable frequency drives. Traditionally, to supply electric power in an isolated microgrid without a conventional generator by forming the grid, a GFM inverter is used as the master voltage source to provide voltage magnitude and frequency signals for the other generators and inverter-based resources operating in current source mode (GFL). If the measured voltage is low, the GFM inverter automatically increases its voltage output until the setpoint voltage is attained. This is normally done by increasing the reactive power output of the inverter via the internal feedback PLL circuits in the inverter firmware. Similarly, if the measured frequency is low, the GFM inverter will increase its real power output until the desired frequency is reached. The result of increasing the frequency is that the real power output of the inverter changes due to the voltage angle difference between the inverter and the grid. This is due primarily to the fact that power flow increases as a function of the voltage angle difference between the source voltage and the load voltage and the source and receiving voltage magnitudes—and varies inversely with respect to the impedance. The electric frequency setpoint for the GFM inverter is normally at a nominal value of 50 or 60 Hz. The setpoint for voltage is normally at the nominal voltage of the low voltage (LV) bus (typically 360 to 600 volts) supplied by the inverter directly. Higher voltage applications are achieved using step-up transformers. If the setpoint of frequency is not at 50/60 Hz exactly, the power output of the inverter will continually change. Accordingly, at steady state the frequency must exactly equal the nominal frequency.

Normally, a backup fossil fueled generator is available to meet demand when renewable energy sources are not available. The existing approach is to use fossil generators as the primary voltage source and the IBR runs in GFL mode. The issue with this approach is that when switching to 100 percent IBR, at least one of the GFL inverters must switch to GFM mode. This often requires a black start of the microgrid, that can last for minutes or longer.

If the demand at the Low Voltage (LV) bus in the microgrid exceeds the power supply capability of the power generation resources, the GFM inverter will trip due to overload unless additional current source inverters are supplying power to meet the load. The main issue with this design is that one master inverter provides the electric frequency and voltage signal for the remaining inverter-based resources that could be connected to the bus. If multiple GFM inverters are used, any slight change in frequency or voltage response of any inverter will affect the performance of the other inverters. This can cause power fluctuations between GFMs and potentially cause sustained or even growing (unstable) power oscillations, possibly leading to a complete trip or collapse of the voltage. Accordingly, the traditional practice in microgrid design is to have only one GFM inverter or a backup generator as the voltage source. If the master inverter fails, a secondary/backup inverter will be switched in to be the voltage source.

In some microgrid designs with multiple GFM inverters it is customary practice to expand the so-called droop controls to GFM inverters operating in parallel by dividing the frequency and voltage control responsibilities into droop bands. This improves the coordination of GFM inverters but does not eliminate the power fluctuations due to both measurement error and the fact the droop controllers, typically only defined as a proportional adjustment of power flow due to a change or droop in frequency, always have a steady state offset error. Additionally, droop controllers around the GFM inverters will always tend to oscillate since droop controllers never achieve a steady state setpoint. They continually bounce around the edges of the deadbands, and even with zero deadband, droop controllers have a steady state offset from a nominal setting.

Control of state of charge (SOC) of the battery supplying power to the inverter can be an important part of the control system. Specifically, the second level controller (parent controller that is parent to the child controller controlling the inverter) must control the real power setpoint so that the SOC of the battery remains within levels that support continuous control. For example, if the SOC is at its high limit, there is no control authority for decreasing the real power flow into the network. The controller can only request increasing flow from the inverter that causes the SOC to decrease. An analogous situation is if the SOC is at the low limit or below, the flow into network can only be decreased causing the SOC to increase. The parent controller can control child controller(s) such that the SOC of corresponding battery/batteries remains within level(s) that support control.

The use of “droop” controls in GFM inverters for an IBR electric network has many challenges such as a low or no inertia grid, redundant voltage sources, coordination between GFM inverters, and SOC management of GFM inverters. With low or no inertia, grid frequency will vary significantly for supply and demand balance when there is very little GBR forming in the grid. For example, frequency will not be a good control signal when the grid is formed by all IBR with zero system inertia. With redundant voltage sources, dividing GFM inverters into specific frequency and voltage control bands will require significant planning and real-time operations coordination. With coordination between GFM inverters, significant power oscillation can result when there is poor coordination of timing and magnitude of droop responses from the GFM inverters. With SOC management of GFM inverters, individual energy storage SOC with GFM inverters may be drained from continuous operations without supervisory control.

To address these and/or other challenges, multiple GFM inverters can operate in parallel at various locations of the network by adding, via respective child controllers, a fast feedback loop around each GFM inverter. Each child controller can be coordinated by a parent controller and a parent controller can coordinate multiple child controllers. The GFM inverter can emulate a GFL inverter in operations since the child controller is sent real and reactive power commands from its parent controller. Each child controller controls both the real and reactive power flow from its GFM inverter at a specified real and reactive power setpoint from the parent controller. The child controller can be a 2×2 real (P) and reactive (Q) power decoupling control that supports independent P and Q setpoint commands in the same control loop. The inputs and outputs of the controller can include: (a) input real and reactive power (PQ) measurements, (b) input PQ setpoints, and (c) output Voltage (V) and Frequency (F) setpoints to the GFM inverter. The GFM inverter itself can include internal VF measurements for its own fast internal control loops implemented in the firmware of the inverter.

If a GFM inverter is operated without the added control loop, its power will tend to fluctuate or oscillate due to differences in internal loop tuning on each GFM inverter in the local network and will be affected by the noise and inaccuracy in the voltage and frequency measurements. The oscillations can cause power flow instability in electric power networks consisting of multiple GFM inverters. It has been reported that the slight tuning differences between GFM inverters is the cause of increasing frequency oscillations in distribution grids. The oscillations reported thus far are in the range of 11-18 Hz. Using techniques described herein, any oscillations in the local grid are dampened by utilization of a parent controller.

The child controller can include integral action to assure a steady-state error of zero and can additionally or alternatively decouple the relationship between real and reactive power. This controller, unlike droop controls, eliminates steady state error thereby reducing fluctuations and improving stability while compensating for the natural coupling between real and reactive power and voltage and frequency (Ohm's law). If the controller has zero error, the voltage angle (P) and the power angle (Q) between the child controller and the GFM inverter are constant, preventing ringing of power.

This additional control loop can either be added externally to an existing IBR operating as a GFM inverter or built-in to a GFM inverter within its native firmware. Furthermore, the external control loop can be provided by local hardware, or by software locally or remotely. This control loop can include a two-input by two-output (2×2) decoupling model-reference controller with PQ inputs and VF outputs.

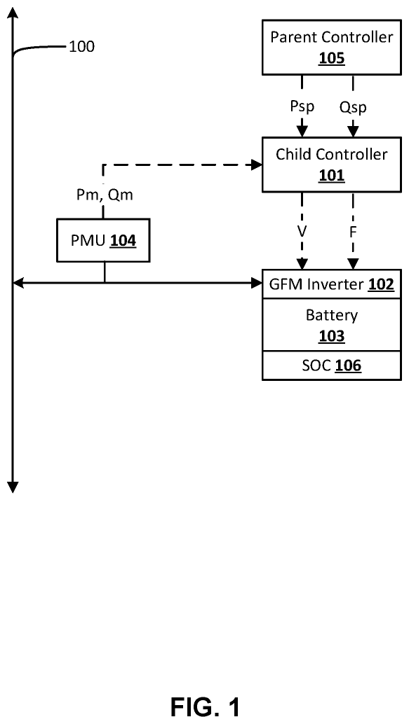

Turning now to FIG. 1, a block diagram of an example child controller 101 is shown. The child controller 101 controls an energy storage unit such as a battery energy storage system (BESS) that includes a battery 103 with a GFM inverter 102 that is connected to an electrical network bus 100. The child controller 101 is a two input and two output (2×2) controller that receives power setpoints Psp and Qsp from a parent controller 105, which is a higher-level controller. The parent controller 105 and/or the child controller 101 can run at high-speed, such as at a sub-second rate supported by the data rate of a time-synchronized PMU 104. The control execution rate can depend on the data rate of the PMU 104 and can be, for example, 60 Hz.

The V and F setpoints provided to the GFM inverter 102 are determined by the outputs of the two-by-two decoupling child controller 101. These V and F setpoints control signals to the GFM inverter 102 cause the real and reactive power of the GFM inverter 102 to change in response to a change in V and F setpoints. The GFM inverter 102 will output real power (P) and reactive power (Q) that is needed to meet the V and F setpoints issued by the child controller 101. The internal VF control of the GFM inverter 102 is handled by the firmware of the GFM inverter 102 in what are called phase locked loops (PLL). In other words, child controller 101 is setting the V and F target setpoints of the internal PLL controller in the GFM inverter 102. The PLL controller includes two independent PID controllers in most inverter applications.

In implementations disclosed herein, the child controller 101 continuously sends changes in V and F setpoints to the internal GFM inverter 102 setpoints until the inverter P and Q outputs (Pm, Qm), as measured by the PMU 104, reach the specified setpoints (Psp, and Qsp) as shown in FIG. 1. Child controller 101 can be a fast discrete time feedback controller that can include time delay compensation and is tuned to provide a fast closed loop response with minimal overshoot and rapid settling time. The child controller 101 can run at a data rate of nominal grid rates (50/60 Hz) or at an even higher rate supported by the time synchronized measurements from the PMU 104 or a point on wave measurement. This provides uniform sampling intervals starting at the top-of-second (GPS time). The child controller 101 itself can be implemented using Z-transforms.

The practical and desirable closed loop response of the inverters in BESS available at present with respect to a change in Psp and Qsp should be less than a few cycles (<100 msec) to address rapid power disturbance around 11 to 25 Hz that are currently seen in grids. As smaller island grids are automated this oscillation frequency will continue to increase. The controlled or closed-loop response of the inverters must be at least two times faster than the power disturbances. Such fast closed-loop response of the inverters will dampen power oscillations and prevent undesirable actions from system protection devices.

The GFM inverter 102 is normally connected to a DC power source such as an EV bi-directional charger or a battery 103 as shown in FIG. 1. In applications with batteries, managing the SOC 106 of the battery 103 is an important task. The SOC 106 is the measurement of the amount of energy stored in the battery and is often measured in kWh or % of the kWh storage capacity of the battery. If the SOC 106 is outside of its upper and lower bounds, the GFM inverter 102 cannot be used for bi-directional control. In implementations disclosed herein, the SOC 106 is managed by the next higher level supervisory controller in the system (referred to as parent controller 105 in FIG. 1) running a power optimization algorithm to determine the Psp and Qsp setpoints of each child controller (including child controller 101) that will cause the SOC levels of each of the child controllers to be equal. Note that both the Psp and Qsp values can be positive or negative. For example, to charge the battery 103, the Psp must be negative, but Qsp can be either positive or negative since the GFM inverter 102 is designed to operate in all four quadrants in the PQ plane.

The nominal frequency setpoint to the GFM inverter 102 can be exactly 50/60 Hz at steady state. If the frequency of the GFM inverter 102 is not at nominal, the voltage angle difference between the GFM inverter 102 and the electrical network bus 100 will change, causing power to flow in the direction of the lower voltage angle. If the frequency of the GFM inverter 102 is exactly nominal, the voltage angle will be constant, representing a constant power exchange with the electric network bus 100 (in or out of the GFM inverter 102). Any change of voltage at the electric network bus 100 will also cause a change in power flow and hence the internal controls of the GFM inverter 102 will respond accordingly to maintain the Psp and Qsp setpoints. This control function is handled by the next level of control as described herein.

With this child control loop added to an existing GFM inverter 102, the GFM inverter 102 operates like an emulated GFL inverter. In many applications there will be multiple GFM inverters that operate in parallel and that are controlled by a single parent controller.

In various implementations, a new setpoint for real and reactive power (Psp and Qsp) is received by each of multiple child controllers from an external source, such as parent controller 105. Initially, the default settings for Psp and Qsp can be zero, representing the condition of the GFM inverter 102 in a “black start” situation when no power is supplied. Normally, this would be the condition when the GFM inverter 102 is first turned on. Additionally, the default settings for V and F, provided by a child controller such as child controller 101, would be the local bus nominal setting for voltage (e.g. 480 VAC) and nominal frequency (e.g. 60 Hz) of the power network. The error signal of the child controller 101, can use the nominal grid frequency used to create a new setpoint for the V and F setpoints of the voltage source inverter via internal PID coefficients inside the 2×2 controller, including the compensation provided by the decoupling matrix inside the child controller. The GFM inverter 102 will adjust its internal PLL electronics to cause the output voltage to achieve its new desired setpoint value.

If the frequency deviates from nominal, the voltage angle between the electric network bus 100 and the GFM inverter 102 will continue to change since angle is the integral of frequency. The voltage angle rate of change is the frequency difference between nominal and the actual frequency. Thus, a large frequency change will cause a large rate of change of voltage angle. The child controller 101 will detect, via output from PMU 104, that the apparent power is increasing beyond the setpoint value and send incremental changes in frequency (F) and voltage (V) to the GFM inverter 102 to maintain the Psp and Qsp provided to the child controller 101 by parent controller 105. At steady state, the GFM inverter 102 will output power at the nominal frequency at the real power setpoint (Psp and Qsp) as commanded by the parent controller 105. The child controller 101 causes a steady-state voltage angle difference between the inverter and the electric network bus 100, resulting in corresponding apparent power flow. The frequency commands are small setpoint changes up and down to get to the desired power output and then frequency will be returned to nominal at steady state.

The child controller 101 can be of the traditional “position” controller type. At steady state, the VF setpoints to the inverter are V=nominal electric network bus 100 voltage plus a small offset to handle the impedance voltage drop between the inverter and the electric network bus 100 voltage, and the F setpoint will be nominal 50/60 Hz.

It is important that the GFM inverter 102 internal frequency measurement has a high resolution and accuracy, typically 0.001 Hz measurement error or less. If the frequency measurement is not accurate and/or is in low resolution, there will be some jitter that cannot be controlled by the child controller 101. This will cause small fluctuations of real and reactive power.

Note also that in various implementations the GFM inverter 102 must be able to operate in all four quadrants in the PQ plane. In implementations disclosed herein, positive power is flowing from the GFM inverter 102 outward and toward the electric network bus 100 and negative power is flowing from the electric network bus 100 to the GFM inverter 102 that then transfers the excess energy into the battery 103 via its DC terminals, such as at about 1000 volts DC. It will not be uncommon for the real power setpoint Psp to be negative at certain times of the day. This is needed to maintain the SOC 106, of the battery 103, of the GFM inverter 102, within controllable levels. At the same time, it is common for the Qsp to be positive, i.e. operating in the second quadrant of the PQ plane.

Various implementations disclosed herein can control isolated microgrids and network disconnected microgrids using multiple GFM inverters supervised by child controllers integrated with other GFL devices. Child controllers operate to PQ setpoints that are defined by the next higher level of control (i.e., parent controller(s)). This is akin to cascade control systems that are used extensively in other industries. There are other uncontrolled devices on the electric network bus either supplying power or absorbing power (both real and reactive).

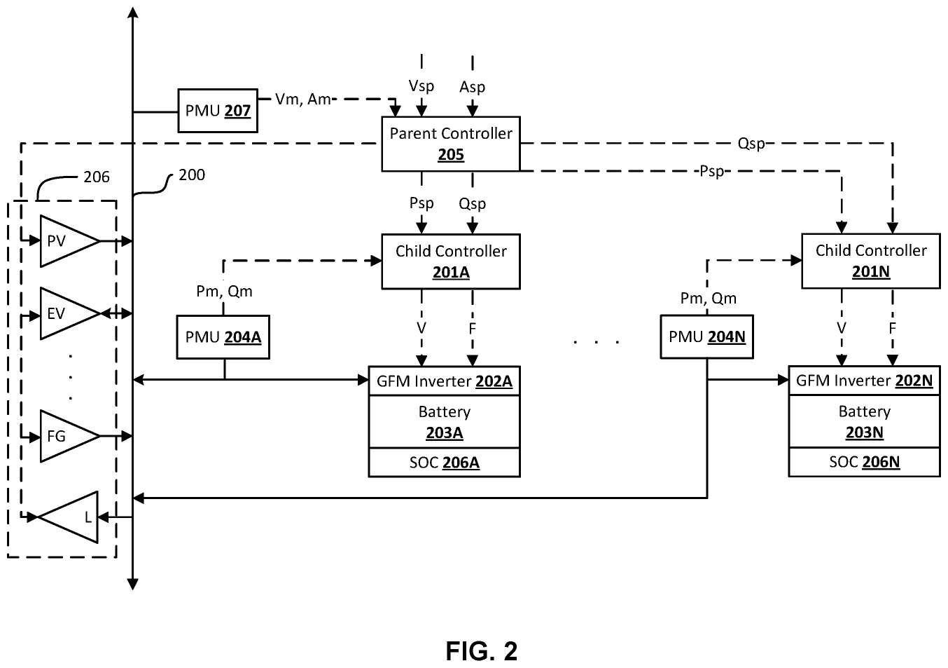

Turning now to FIG. 2, an example configuration of a microgrid controller with multiple GFM inverters 202A-N in an isolated electric grid is provided. FIG. 2 illustrates an electric network bus 200 connected with multiple GFM inverters 202A-202N supervised by a parent controller 205 and includes other controllable power resources 206. The inputs to child controllers 201A-201N come from corresponding ones of PMUs 204A-204N and the parent controller. The inputs to the parent controller 205 come from PMU 207 and, optionally, higher-level controller(s). Each of the PMUs 204A-204N can measure the output of a corresponding one of the GFM inverters 204A-204N. The PMU 207 can measure the electric network bus 200.

Some of the controllable power sources 206 can be voltage following devices, typically referred to as current sources or GFL resources. Such voltage following devices can include solar PV, electric vehicle (EV) service equipment, fossil fueled power sources (FG), and/or controllable loads (L). Some of the loads and generation sources can be controlled by the parent controller 205 or, if uncontrolled, considered as measured or unmeasured power disturbances. In the case of measured disturbances, the inputs are considered feedforward inputs to the parent controller 205.

The parent controller 205 reads network bus 200 voltage magnitude and voltage angle (Vm, Am) via measurements from PMU 207. The parent controller 205 supervises multiple child controllers 201A-201N by sending them Psp and Qsp setpoints at a data rate equal to or slower than that of the child controllers 201A-201N. In doing so, the parent controller 205 can utilize a splitter function to distribute the specific Psp and Qsp setpoints to corresponding ones of the child controllers 201A-201N and to control the SOCs of the batteries 203A-203N associated with the GFM inverters 202A-202N controlled by the child controllers 201A-201N, and in view of the Vsp and Asp setpoints of the parent controller 205. For example, the child controllers 201A-201N can each run at 60 Hz and the parent controller 205 can run at 10 Hz. The splitter function of the parent controller 205 optionally also sends control commands to other controllable resources on the electric network bus 200, such as controllable power resources 206. The basic power control functions of child controllers 201A-201N and the parent controller 205 are similar but can have different tuning coefficients and/or different filters. The parent controller 205 includes a splitting function that allocates real and reactive power (Psp and Qsp) setpoints for the child controllers 201A-201N such that the setpoints are achieved and the SOCs of all batteries 203A-203N are equal or near equal (e.g., within one percent, five percent, or other percent of being equal). For example, all batteries 203A-203N can be at about 50 percent at steady state.

The splitter function of parent controller 205 allocates the total required power to its child controllers 201A-201N, and other controllable energy resources 206 connected to the electric network bus 200. Accordingly, all energy sources supplying the electric network bus 200 are either GFM voltage sources acting as emulated GFL current sources or are natively configured GFL current sources. In one example application, the splitter power allocation of the parent controller 205 is based on the energy capacity and response capabilities of the GFL inverters 202A-N, and power dispatch priority of the child controllers 201A-201N. When there are energy storage units associated with the controllable resources, the parent controller 205 can be responsible for balancing the SOC those energy storage units under its control. For example, the parent controller 205 can be responsible for balancing the SOC of batteries 203A-203N and/or energy storage unit(s) of controllable energy resource(s) 206. More generally, for the energy storage units (e.g., batteries 203A-203N) with associated GFM inverters (e.g., GFM inverters 202A-202N), the parent controller 205 will balance their SOC value within an operating time window to provide maximum control authority for the complete microgrid system.

Parent controller 205 receives, via PMU 207, real time values of the voltage and voltage angle (Vm, Am) of the electric network bus 200 and uses these measurements and current Vsp and Asp to compute the Psp and Qsp setpoints for the child controllers 201A-201N. The Vm, Am measurements can be time synchronized to the GPS clock and can be sent to the parent controller 205, by PMU 107, at 50/60 Hz or other rate(s). This method of controlling multiple GFM inverters, such as GFM inverters 202A-202N, is especially impactful in a grid with all IBR (without spinning generators or inertia) supplying the network because power control is not primarily based on the frequency signal.

In such an isolated microgrid application, supply and demand balance is achieved by controlling Vm and Am at the electric network bus 200 to the desired setpoints Vsp and Asp. For example, maintaining the voltage angle at a constant level, including zero (Asp=0) will result in zero accumulated nominal frequency variation resulting in the time error, relative to the GPS clock, being zero. This means every consumer on the isolated microgrid will have the correct time on their analog clocks. This is important on small islands powered by conventional diesel engines, where the time error can be in minutes.

The Utility industry has used frequency as the primary control variable for the past 100 years and will have to transition to voltage angle and voltage magnitude (defined as a state variable) for control. Interestingly, frequency is not used in load flow models (except as a parameter in impedance calculations). Rather, only voltage angle at the slack bus is used assuming nominal constant frequency. That is, the voltage angle is constant and normally assumed to be zero. The above-described control system can be referred to as a “state variable” controller. In an isolated microgrid case, the main electric network bus is the slack bus, and it is actively controlled to zero value unwrapped voltage angle.

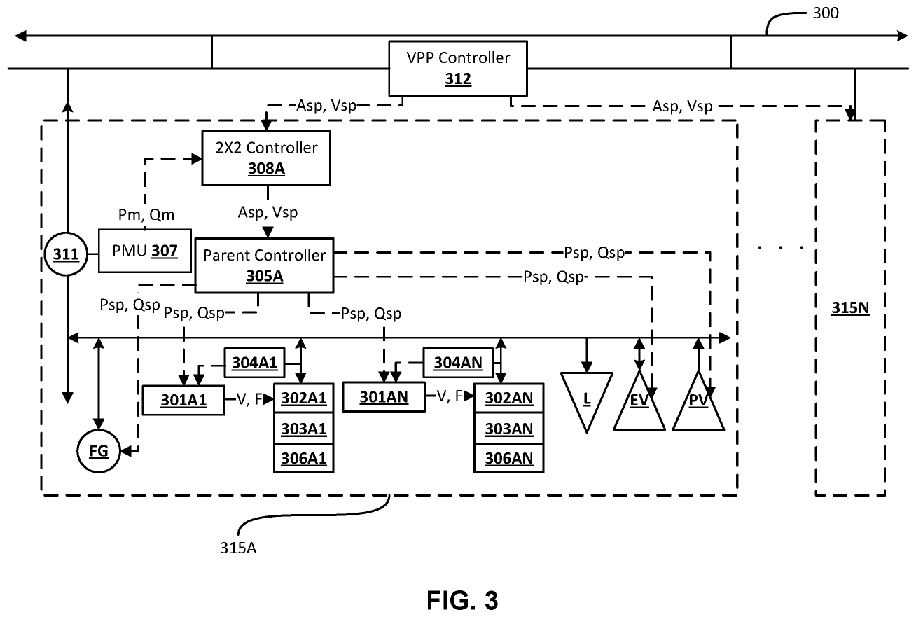

Turning now to FIG. 3, implementations for controlling a heterogenous mix of distributed energy resources (DERs) (e.g., GFM inverter-based resources and/or GFL resources) in a regional grid, to provide redundant voltage sources and maintain a net power flow target, are described. Such implementations can be used to control virtual power plants (VPPs) that contain one or more full-time voltage sources.

There has been growing interest in the concept of a VPP where many renewable energy resources are managed together by an aggregator entity to supply power to the electric network. All power sources are behind a meter (real or virtual) that measures the power flowing into the electric network.

A VPP is an aggregation of distributed resources so they can be dispatched like a traditional power plant. Often VPPs focus on real power dispatch only because some of the resources are connected at different points of the electric network as GFL resources behind different meters where reactive power requirements can be different. Therefore, traditional VPP is limited to real energy dispatch with a slow control time response, such as a control time response that is in minutes (e.g., more than one minute, more than two minutes, etc.). The distribution of resources at different points of the network also makes it difficult for the Distribution System Operator to control power flow within network constraints.

VPP has much greater benefits to support a network with increasing IBRs but requires an advancement in control capabilities. For example, faster control response, reactive power management, and multiple GFM inverters operation are important advancements to maximize VPP benefits.

Implementations described herein utilize the aggregated control of distributed resources from different metering points as well as a mix of distributed resources inside a single metering point in the power network, where the point is Point of Interconnection or Point of Interest (POI) as defined in IEEE Standard 2030.7. This point is also called the common coupling (PCC) as defined in the IEEE 1547 Interconnection standard.

In FIG. 3, a distribution substation bus 300 is illustrated along with local microgrids 315A-315N that each include a corresponding single metering point, corresponding distributed resources inside the single metering point, and corresponding controllers to provide redundant voltage sources and maintain a net power flow target. Components of local microgrid 315A are illustrated and described herein, but it is understood that additional local microgrids (e.g., 315N) can each have similar components as those of local area grid 315A.

The VPP controller 312 can provide corresponding Asp and Vsp setpoints to each of the local microgrids 315A-N. The Asp and Vsp setpoints can be split amongst the grids, by the VPP controller 312, based on various criteria. For example, the splitter function of the VPP controller 312 can be based on economic bids by the local microgrids 315A-315N. It can be the responsibility of the local microgrids 315A-315N to bid into the VPP controller 312 the power that they can deliver, based on how they control their battery state of charge.

The real and reactive power measured (Pm, Qm) by a PMU 307 at a metering point 311 of the local microgrid 315A are shown in FIG. 3. There is a heterogeneous mix of power generation sources and loads in the local microgrid. They may include, as illustrated in FIG. 3, solar (PV), electric vehicle service equipment (EV), fossil generators (FG), and/or controllable and/or non-controllable loads (L). Some of the loads and generation sources can be controlled or, if uncontrolled, are considered as measured or unmeasured power disturbances.

A 2×2 controller 308A receives the Asp and Vsp set points from the VPP controller and the Pm, Qm measurements from the PMU 307 at the metering point 311. The 2×2 controller 308A provides, to the parent controller 305A, aggregated Asp and Vsp set points based on these values. Accordingly, the parent controller 305A has visibility to the power flow to the distribution substation bus 300 connected at the metering POI 311. Furthermore, the addition of a child control loop will enable the GFM resources to emulate GFL resources.

The parent controller 305A supervises all controllable resources, including multiple child controllers 301A1-301AN by sending them Psp, Qsp setpoints at a rate equal to or slower than the child controllers 301A1-301AN. The splitter function of the parent controller 305A will control the aggregated power flow by distributing the specific control setpoints to the child controllers 301A1-301AN and/or other controllable resources. The child controllers 301A1-301AN each take corresponding power measurements from a corresponding one of PMUs 304A1-304AN, along with the corresponding provided Psp, Qsp setpoints, to determine the corresponding V and F setpoints to provide to corresponding ones of the GFM inverters 302A1-302AN (e.g., as described above with respect to FIG. 2). Each of the GFM inverters 301A-302AN is associated with a corresponding one of the batteries 303A1-303AN each having a corresponding SOC 306A1-306AN.

Accordingly, all energy sources controlled by the parent controller 305A are either GFM voltage sources acting as emulated GFL current sources or natively configured GFL current sources. In some applications, the splitter power allocation may be based on the energy capacity and response capabilities of the GFL resources, and priority of the child controllers.

The controllable GFL resources may include conventional fossil generators (FG). Such traditional power supply may be needed during times of low solar power production or at night. The power commands will be such that the generators operate at their minimum heat rate to minimize carbon emissions and the generators are run in ISOC mode. In various implementations, multiple GFM inverters as the voltage source are forming the grid and are regulating supply-demand balance at all times. The GFL resources including fossil generators and controllable resources are dispatched accordingly to achieve the aggregated power flow of multiple metering points contracted by the VPP.

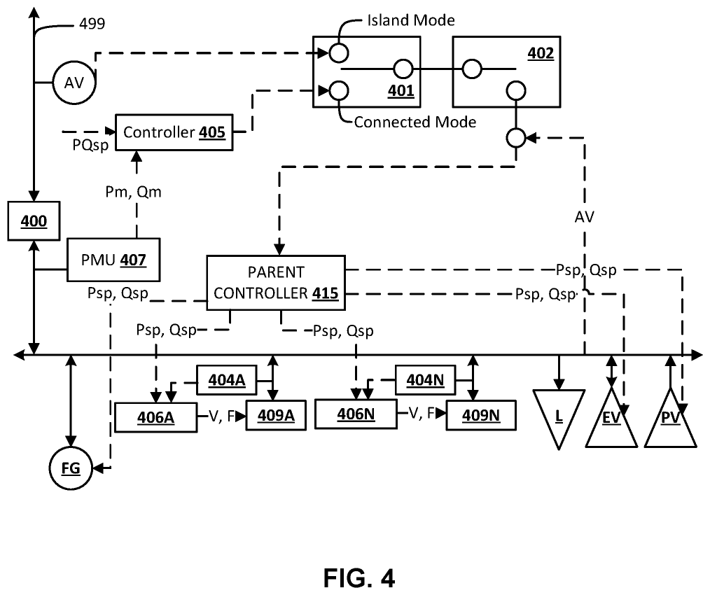

Turning now to FIG. 4, implementations for controlling power flow in a large regional grid, that includes networked local area microgrids and facility microgrids, are described. In this configuration, the POI of a networked microgrid is designed to operate as a controllable load or source of power within an electric power network: hence the name “networked microgrid.” This means fast flow control of both real and reactive power including import and export of apparent power as well as virtual disconnection (P and Q=0) and/or operating with a physical disconnection by opening the circuit breaker at the POI. These microgrids are typically implemented in commercial, residential, and industrial applications. This requires a three-level hierarchy since it must operate in parallel with a connected Utility grid and provide the Utility with the means to control flow at the POI of the microgrid. The frequency of the microgrid when it is network connected and the frequency of the Utility grid must both be nominal in the steady-state and the angle between the Utility grid and the microgrid is at a specified constant value. The microgrid controller acts as a current source controlled either by the Utility or by the network connected microgrid owner. This means that the POI of the microgrid will follow the angle and voltage of the Network to which it is connected. The power flow into or out of the microgrid is emulating a current source to the Utility grid. This allows an arbitrary number of these types of microgrids to be connected in a distribution system.

Note that in the disconnected state, it is desirable for the microgrid to hold the bus voltage angle and voltage constant for on-demand re-connection. In other words, the frequency of the islanded grid will track the utility grid's frequency. This isolated microgrid mode is referred to as network-disconnected microgrid.

This also provides the means to organize network connected microgrids in a hierarchy of cascaded controllers to control the entire power grid (also referred to as the Interconnection, for example there are currently three Interconnections in North America). While connected, the POI of each microgrid is controlled to a specified economic angle that will cause power to flow into or out of the microgrid at the optimal value relative to the connected network.

A block diagram of a networked microgrid controller is shown in FIG. 4. The networked microgrid includes a circuit breaker/switch 400 connecting the microgrid to the main electric power network 499. This circuit breaker 400 can be opened/closed on demand from either the microgrid controller 405 itself or from another controller such as a protective relay. When the circuit breaker 400 is in a closed position, the microgrid is network-connected and when the circuit breaker 400 is in open position, the microgrid is network-disconnected.

The microgrid logic shown in block 401 will determine the setpoints provided to parent controller 415. These are the angle and voltage setpoints from either microgrid controller 405 if in connected mode or from the AV measurements from the grid in disconnected mode. This allows the parent controller 415 to follow the voltage and angles of the grid when disconnected. The outputs from microgrid controller 405 or AV measurements from controller parent controller 415 are the setpoint inputs to the microgrid controller 405 depending on the operating status of circuit breaker 400. The transitions to/from network-connected to network-disconnected are bump-less so the loads inside the microgrid boundaries do not experience any flickers (per ANSI definition). The control logic applies to both planned and unplanned network disconnection.

To set up the operation of the IBRs in full-time GFM mode within a networked microgrid for both network-connected and network-disconnected modes, the microgrid controller 405 and switching logic 401 and 402 are added. This becomes a three-level hierarchy of multivariable networked microgrid controllers. Child controllers 406A-406N control the output of the GFM inverters 409A-409N. Parent controller 415 specifies the setpoints for child controllers 406A-406N and child controllers 406A-N respond accordingly, also taking into account measurements from corresponding PMUs 404A-N. Parent controller 415 gets its setpoints from either the grid directly when in disconnected mode or from the output of microgrid controller 405 if in connected mode. Note that parent controller 415 setpoints are voltage and angle.

There are several (N) of GFM inverters 409N (typically up to 50, but no real limit) and corresponding battery systems each supervised by a corresponding one of the child controllers 406A-406N. These child controllers 406A-406N provide VF commands to the GFMs 409A-409N. There is one parent controller 415 sending PQ commands to all controllable devices inside the boundaries of the microgrid (e.g., to child controllers 406A-406N, L, EV, PV, FG). This includes sending PQ commands to FG operating in ISOC mode (they follow the grid and get PQ commands). The splitter function in the parent controller 415 distributes the required power flow to the child controllers 406A-406N and other controllable resources. This includes computing the optimal power flows for all controllable resources that maximizes a multi-objective function subject to local microgrid electrical constraints (voltage and thermal) and energy requirements for each of the batteries associated with the GFM inverters. Additionally, if use of FG and/or other FG(s) is required, for example at night or in extended periods of no renewable energy, the fossil generation will be turned on in base load mode following the frequency of the GFM inverters 409A-N that are operational.

The SOC information from each battery system corresponding to the GFM inverters 409A-N is passed to the parent controller responsible for managing the SOC level of each controllable energy storage unit.

The Utility industry has used spinning generators for grid formation with frequency as the primary power regulation variable for the past 100 years. Implementations disclosed herein enable the possibility to transition to voltage angle and voltage magnitude (defined as a state variable) for full control of a microgrid. It is important to point out that frequency is not used in load flow models (except as a parameter in impedance calculations) in some of those implementations. Rather, only voltage angle at the slack bus is used assuming nominal constant frequency, that is the voltage angle is constant and normally assumed to be zero. The above-described control system can be referred to as a “state variable” controller. In the case of an isolated microgrid, the main bus is considered the slack bus, and it is actively controlled to an unwrapped voltage angle of zero value.

There is an additional benefit in maintaining the voltage angle at zero A (sp)=0 when the microgrid is operating in a true island mode. Such control capability will guarantee that the time error relative to the GPS clock will be zero. This means every consumer on the isolated microgrid will have the correct time on their analog clocks. This is important on small islands powered by conventional diesel engines, where the time error can be in minutes.

In a typical island or isolated grid, there is no POI or external grid to connect to. The main electrical bus is held at a fixed Vsp and Asp to maintain the energy balance of the island. For example, maintaining zero voltage angle and a nominal voltage magnitude with fast closed-loop control is sufficient to keep the grid stable and will provide reverse power flow protection for the generator.

There are four modes of operation of a networked microgrid (1) connected, (2) disconnected, (3) transition from disconnected to connected and (4) transition from connected to disconnected.
(1) Connected mode. The level 2 parent controller parent controller 415 described above is supervised by a level 3 networked microgrid controller 405 which uses measured values of the power flow into the microgrid (PQ) just downstream of the breaker as measurements from PMU 407 and sends outputs of microgrid controller 405 of Asp and Vsp setpoints to the parent controller 415. When operating as an independent “prosumer”, the PQ setpoints of the microgrid controller 405 are computed based on an economic criterium. The parent controller 415 splitter issues control commands to fossil fueled generators only when necessary. The commanded value to the generator is to operate at steady state at their optimal heat rate to minimize carbon emissions. One method to determine if a generator is needed is when the error signal to parent controller 415 develops an offset from zero. The parent controller 415 then orders the most efficient generator (e.g., of multiple FGs) to turn on at its minimum heat rate. This will minimize carbon emissions. The parent controller 415 will turn off the least efficient generators (e.g., of multiple FGs) in order until all fossil generators are off when the error signal of parent controller 415 saturates on the high side. This mode of control is often called Hydrocarbons-On or Hydrocarbons-Off (HON of HOFF). In HOFF mode, the system operates carbon free.

In network-connected mode, microgrid controller 405 sends Asp, and Vsp signals to parent controller 415 to achieve the desired PQ setpoints of microgrid controller 405 (this is the desired PQ of the power flowing into/out of the microgrid). Note that parent controller 415 is the same controller (parent controller), described in the isolated island case, except in that case the setpoints are constant for microgrid controller 405: at V=nominal voltage and A=zero.
(2) Disconnected mode. The disconnected mode is equivalent to the isolated microgrid mode described above but requires the ability to seamlessly re-connect and disconnect from the Utility grid.

In the network-disconnected mode, if the Utility grid is stable, the angle and voltage setpoints (Asp, Vsp) of parent controller 415 are set equal to the angle and voltage of the utility network so that a reconnection can be made at any time with zero bump in accordance with the connection requirements of IEEE 1547. This is referred to as an “angle tracking” function. Both the voltage angle and the voltage magnitude of the main grid are monitored and used as the setpoint of parent controller 415. This function tracks the voltage and phase angle of the main grid when the breaker is open (disconnected from the grid). This allows the microgrid to reconnect to the main grid instantly and on demand without the use of a synchronizing relay that takes seconds to minutes to facilitate grid re-connection.

In the case where the microgrid may remain disconnected for an extended period of time due to instability or reliability issues in the main utility grid, the voltage angle setpoint of parent controller 415 is set to zero. This is the same mode as the isolated microgrid case described above and will maintain the time error at zero and provides zero drift of the time error in the microgrid.

In case of a wide area blackout, the microgrid automatically disconnects from the grid and maintains a zero-voltage angle setpoint while disconnected. When the Utility grid is again stable, the angle tracking function is enabled and a seamless reconnection to the main grid is made. Upon initial circuit breaker closing, there is no power flow between the Utility grid and the microgrid since the voltage angle difference is zero. This is a major innovation in system restoration with each disconnected microgrid potentially offering black start for the Utility grid.

In the disconnected mode, the internal DOC of parent controller 415 determines optimal PQ settings for each of the child controllers 406A-406N to maximize the objective function in disconnected mode. The allocation of power to the loads in disconnected mode, is to maximize the benefit from the loads inside the microgrid. This is often the maximum time-to-live of critical loads. The SOC(s) of the battery/batteries can be a key variable in maintaining the objective function.
(3) Transition from disconnected to connected mode-reconnecting. The disconnected microgrid is reconnected by switching to the angle tracking mode in logic 401. This function forces the angle of the disconnected microgrid to track the angle of the Utility grid (or another parent microgrid.) When the voltage angle difference is within the specified range in IEEE 1547 standards, the circuit breaker 400 will close reconnecting the microgrid to the Utility grid.

Logic 401 is the switching function that is used to send Asp and Vsp commands directly to parent controller 415 to track the main grid A and V. This is needed to support reconnection on demand without any inrush or outrush of current. In the disconnected mode, the voltage angle tracking function can be adjusted to provide fast, slow or no tracking. In most cases, fast tracking will be enabled to provide the Utility with the ability to reconnect the microgrid quickly to provide needed grid services.
(4) Transition from connected mode to disconnected mode-disconnecting. The microgrid can be disconnected either unplanned or on a planned schedule. In an unplanned situation, switching logic 402 and 401 receive a disconnect signal from the Utility to open the circuit breaker 400 or a protective relay trips the circuit breaker 400. Logic 401 and 402 immediately send an Asp=0 and Vsp=nominal signal to parent controller 415. The step change to Asp in parent controller 415 is used in the feedforward loop of parent controller 415 to instantly change P and Q setpoints to the child controllers 406A-N based on the splitter ratios. This is an instantaneous explicit energy balance. All controllers described herein can include setpoint feedforward control. This allows the microgrid to separate from the main grid on demand without warning and/or allows microgrid controller 405 to self-initiate a disconnection when detecting a fault at the POI. When the main grid fails, or if the Utility needs to rapidly shed load, the PQ flowing into the microgrid from the main grid, is automatically compensated by the setpoint feedforward control function in the microgrid controller 405, that passes it to parent controller 415, that in-turn passes it to all child controllers 406A-406N. This function results in a step change in the PQ commands to the child controllers 406A-406N, thereby minimizing power surges and voltage flicker inside the microgrid.

In a planned disconnection, microgrid controller 405 receives a planned disconnect signal from the Utility or local operator. The microgrid controller 405 sends a planned disconnect signal to parent controller 415 to ramp its Asp to the voltage angle A of the grid. When the voltage angle of the connected microgrid reaches the voltage angle of the grid, the circuit breaker is opened. This system can also operate in virtual disconnected mode by following the angle of the Utility grid resulting in no power flow at the POI.

This method of grid control of GFM inverters 409A-409N for both primary grid formation and power regulation of a mix of controllable resources, can be used for further advancements in grid control. These advancements include time error management, optimal energy dispatch at the system level, and/or optimal energy management at the local level. Each of these is described in more detail in turn below.

With time error management, note that the voltage angle from PMUs is the unwrapped voltage angle difference from an imaginary infinite bus in the sky. If the bus voltage angle is zero, time is equal to GPS time. This is important for small islands that use fossil generators for primary frequency control. Typically, in these island cases, the time error can be in minutes. By tracking the accumulated time error from GPS time, the power setpoints to the child controllers can be biased to reduce the accumulated time error towards zero. This will keep the time error to zero in physically isolated microgrids. In connected systems, the time error is dependent on the time error of the connected grid. If the entire interconnection is GFM based, the time error will be zero. In this application the measurements on the bus are positive sequence voltage magnitude and voltage angle (state of the bus) assuming the system is a well-balanced 3-phase network. In the case of unbalanced phases in a 3-phase AC system, three instances of the proposed control method in single phase are implemented. This will require an additional parent controller to send PQ commands to the individual single-phase inverters to balance the three phases at the common bus. In effect, each single-phase system with controllable resources can be treated as an independent networked microgrid.

With optimal energy dispatch at the system level, besides grid formation and regulation using GFM inverters, the hierarchal design and coordination of a network with a controllable mix of resources and downstream networked microgrids require mixed asset and energy storage economic dispatch, quite different than generator economic dispatch of the past. Note that the Asp and Vsp setpoints of a parent controller will send PQ setpoints to all controllable devices via the splitter. This includes sending commands to traditional fossil generators as needed to meet demand. Most fossil generators burn more fuel at minimum loading than running at the optimal heat rate. Since fossil generators are no longer providing the function for grid formation and regulation in implementations disclosed herein, their power output can be targeted at their optimum heat rate to minimize fuel cost and carbon emissions. In addition to system level economic dispatch of controllable resources, the parent controller may determine the PQ setpoints to all controllable devices using a reliability objective, such as equalizing power flow and managing energy storage SOC to prepare for emergency operations.

With optimal energy management at the local level, a local networked microgrid connected to the main grid will operate as an electricity producer and/or consumer (prosumer). Besides the network-connected and islanded mode of operation, the controllable mix of resources, downstream networked microgrids, and energy storage units economic dispatch will determine the optimal PQ setpoint of controllable resources for net import or export to and from the microgrid according to real time local electricity needs and overall energy economics. The excess energy produced locally may be used to reduce the net import of electricity or exported for revenue potential, thus enabling maximum utilization and return on investment of these energy assets.

In some implementations, a method, is provided that includes controlling a supply-demand balance of power, in a multi-phase AC electric power system, via power flow dispatch to multiple grid-forming (GFM) inverters and grid-following resources operating in parallel in the multi-phase AC electric power system. Controlling the supply-demand balance can include: iteratively generating, based on a corresponding real power setpoint and a corresponding reactive power setpoint, a corresponding voltage setpoint and a corresponding frequency setpoint for a GFM inverter of the GFM inverters; iteratively providing the corresponding voltage setpoint and the corresponding frequency setpoint to the GFM inverter to cause control of the GFM inverter based on the corresponding voltage setpoint and the corresponding frequency setpoint; and iteratively providing the corresponding real power setpoints and corresponding reactive power setpoints to the grid-following resources.

These and other implementations of the technology disclosed herein can optionally include one or more of the following features.

In some implementations, the corresponding real and reactive power setpoints and the corresponding frequency and voltage setpoints are generated based on a state of charge (SOC) of a battery associated with the GFM inverter. In some of those implementations, the corresponding real and reactive power setpoints and the corresponding frequency and voltage setpoints are generated based on maintaining the SOC of the battery within a level that supports control.

In some implementations, iteratively generating the corresponding voltage setpoints and the corresponding frequency setpoints is performed by a child controller for the GFM inverter and wherein the corresponding reactive power setpoints and the corresponding real power setpoints are generated by a parent controller. In some versions of those implementations, the parent controller further generates, in parallel with generating the corresponding reactive power setpoints and the corresponding real power setpoints, corresponding additional reactive power setpoints and corresponding additional corresponding real power setpoints for an additional child controller for an additional GFM inverter of the GFM inverters. In some of those versions, the method further includes: generating, by the additional child controller and based on the additional corresponding reactive power setpoints and the additional corresponding real power setpoints, a corresponding additional voltage setpoint and a corresponding additional frequency setpoint for the additional GFM inverter; and providing, by the additional child controller, the corresponding additional voltage setpoints and the corresponding additional frequency setpoints to the additional GFM inverter to cause control of the additional GFM inverter based on the corresponding additional voltage setpoints and the corresponding additional frequency setpoints.

In some implementations, iteratively generating the corresponding voltage setpoints and the corresponding frequency setpoints is further based on corresponding real power measurements and corresponding reactive power measurements from a phasor measurement unit measuring output of the GFM inverter.

In some implementations, the supply-demand balance is zero.

In some implementations, the supply-demand balance is the aggregated power flow of the GFM inverters and of any generator-based resources (GBRs), and grid-following resources, and/or controllable loads interconnected in the multi-phase AC electric power system.

In some implementations, the power is, during at least some durations of time, provided solely by the GFM inverters and without any utilization of any generator-based resources (GBRs).

In some implementations, the supply-demand balance is controlled on each phase separately in the multi-phase AC electric power system.

In some implementations, the GFM inverters and one or more generator-based resources (GBRs) and grid-following resources, interconnected in the multi-phase AC electric power system, are represented as network-connected and controllable microgrids. In some of those implementations, the GFM inverters and the one or more GBRs and grid-following resources are controlled to maintain zero power flow at their connection points to facilitate disconnection and connection during black start without power inrush or outrush.

In some implementations, the multi-phase AC electric power system is operated as a network-disconnected microgrid, and the method further includes, while operating as the network-disconnected microgrid, controlling the voltage angle of the multi-phase AC electric power system based on tracking the voltage angle of a power network to which it can be connected at any time.

In some implementations, the multi-phase AC electric power system is operated as a network-connected microgrid and controlling the supply-demand balance of power in the multi-phase AC electric power system includes, while operating as the network-connected microgrid, controlling the real and reactive power at a connection point of the network-connected microgrid.

In some implementations, controlling the supply-demand balance of power in the multi-phase AC electric power system includes selectively dispatching one or more generator-based resources (GBRs) economically by causing them to operate at their minimum heat rate.

In some implementations, the multi-phase AC electric power system functions as a virtual power plant in a large grid.

In some implementations, a method is provided that includes controlling a plurality of grid-forming resources to provide redundant voltage sources in a power network. Controlling the plurality of grid-forming resources can include using fast, multi-level, time-synchronized multivariable feedback controllers to continuously adjust the power flow of the resources at local connection points. The local connection points are of the grid-forming resources to the power network.

These and other implementations of the technology disclosed herein can optionally include one or more of the following features.

In some implementations, all of the grid-forming resources are controlled as emulated current sources controlling real and reactive power by dispatching corresponding voltage magnitude and frequency setpoints to the grid-forming resources.

In some implementations, all of the grid-forming resources are dispatched with a frequency setpoint to control the accumulated voltage angle error, of a designated reference bus, to correct and eliminate the time errors from frequency dependent clocks.

In some implementations, a method is provided that includes controlling a supply-demand balance of power, in a multi-phase AC electric power system that can operate as both a network-connected microgrid and a network-disconnected microgrid. The controlling can be via power flow dispatch to multiple grid-forming resources operating in parallel in the multi-phase AC electric power system. Controlling the supply-demand balance can include (i) while operating as the network-disconnected microgrid: controlling, via the power flow dispatch, the voltage angle of the multi-phase AC electric power system based on tracking the voltage angle of a power network to which it can be connected at any time and (ii) while operating as the network-connected microgrid: controlling, via the power flow dispatch, the real and reactive power at a connection point of the network-connected microgrid.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include one or more processors (e.g., processor(s) of a controller) operable to execute stored instructions to perform a method such as one or more of the methods described herein.

1. A method, comprising:
controlling a supply-demand balance of power, in a multi-phase AC electric power system, via power flow dispatch to multiple grid-forming (GFM) inverters and grid-following resources operating in parallel in the multi-phase AC electric power system, wherein controlling the supply-demand balance comprises:
iteratively generating, based on a corresponding real power setpoint and a corresponding reactive power setpoint:
a corresponding first GFM inverter voltage setpoint and a corresponding first GFM inverter frequency setpoint for a first GFM inverter of the GFM inverters, and
a corresponding second GFM inverter voltage setpoint and a corresponding second GFM inverter frequency setpoint for a second GFM inverter of the GFM inverters,
iteratively providing the corresponding first GFM inverter voltage setpoint and the corresponding first GFM inverter frequency setpoint to the first GFM inverter to cause control of the first GFM inverter based on the corresponding first GFM inverter voltage setpoints and the corresponding first GFM inverter frequency setpoints,
iteratively providing the corresponding second GFM inverter voltage setpoint and the corresponding second GFM inverter frequency setpoint to the second GFM inverter to cause control of the second GFM inverter based on the corresponding second GFM inverter voltage setpoints and the corresponding second GFM inverter frequency setpoints,
wherein the corresponding first GFM inverter frequency setpoints, provided to cause control of the first GFM inverter, at least partially differ from the corresponding second GFM inverter frequency setpoints provided to cause control of the second GFM inverter, and
iteratively providing the corresponding real power setpoints and corresponding reactive power setpoints to the grid-following resources.

2. The method of claim 1, wherein the corresponding real and reactive power setpoints and the corresponding frequency and voltage setpoints are generated based on a state of charge (SOC) of a battery associated with the first GFM inverter.

3. The method of claim 2, wherein the corresponding real and reactive power setpoints and the corresponding frequency and voltage setpoints are generated based on maintaining the SOC of the battery within a level that supports control.

4. The method of claim 1, wherein iteratively generating the corresponding first GFM inverter voltage setpoints and the corresponding first GFM inverter frequency setpoints is performed by a first child controller for the first GFM inverter and wherein the corresponding reactive power setpoints and the corresponding real power setpoints are generated by a parent controller.

5. The method of claim 4, wherein iteratively generating the corresponding second GFM inverter voltage setpoints and the corresponding second GFM inverter frequency setpoints is performed by a second child controller for the second GFM inverter.

6. The method of claim 5, wherein the first child controller is a fast discrete time feedback controller.

7. The method of claim 1, wherein iteratively generating the corresponding first GFM inverter voltage setpoints and the corresponding first GFM inverter frequency setpoints is further based on corresponding real power measurements and corresponding reactive power measurements from a phasor measurement unit measuring output of the first GFM inverter.

8. The method of claim 1, wherein the supply-demand balance is zero.

9. The method of claim 1, wherein the supply-demand balance is the aggregated power flow of the GFM inverters and of any generator-based resources (GBRs), and grid-following resources, and/or controllable loads interconnected in the multi-phase AC electric power system.

10. The method of claim 1, wherein the power is, during at least some durations of time, provided solely by the GFM inverters and without any utilization of any generator-based resources (GBRs).

11. The method of claim 1, wherein the supply-demand balance is controlled on each phase separately in the multi-phase AC electric power system.

12. The method of claim 1, wherein the GFM inverters and one or more generator-based resources (GBRs) and grid-following resources, interconnected in the multi-phase AC electric power system, are represented as network-connected and controllable microgrids.

13. The method of claim 12, wherein the GFM inverters and the one or more GBRs and grid-following resources are controlled to maintain zero power flow at their connection points to facilitate disconnection and connection during black start without power inrush or outrush.

14. The method of claim 1, wherein the multi-phase AC electric power system is operated as a network-disconnected microgrid, and further comprising, while operating as the network-disconnected microgrid:
controlling the voltage angle of the multi-phase AC electric power system based on tracking the voltage angle of a power network to which it can be connected at any time.

15. The method of claim 1, wherein the multi-phase AC electric power system is operated as a network-connected microgrid and wherein controlling the supply-demand balance of power in the multi-phase AC electric power system comprises, while operating as the network-connected microgrid:
controlling the real and reactive power at a connection point of the network-connected microgrid.

16. The method of claim 1, wherein controlling the supply-demand balance of power in the multi-phase AC electric power system comprises selectively dispatching one or more generator-based resources (GBRs) economically by causing them to operate at their minimum heat rate.

17. The method of claim 1, where the multi-phase AC electric power system functions as a virtual power plant in a regional grid.

18. (canceled)

19. (canceled)

20. (canceled)

21. (canceled)

22. A system comprising:
one or more processors operable to execute stored instructions to control a supply-demand balance of power, in a multi-phase AC electric power system, via power flow dispatch to multiple grid-forming (GFM) inverters and grid-following resources operating in parallel in the multi-phase AC electric power system, wherein in controlling the supply-demand balance one or more of the processors are to:
iteratively generate, based on a corresponding real power setpoint and a corresponding reactive power setpoint:
a corresponding first GFM inverter voltage setpoint and a corresponding first GFM inverter frequency setpoint for a first GFM inverter of the GFM inverters, and
a corresponding second GFM inverter voltage setpoint and a corresponding second GFM inverter frequency setpoint for a second GFM inverter of the GFM inverters,
iteratively provide the corresponding first GFM inverter voltage setpoint and the corresponding first GFM inverter frequency setpoint to the first GFM inverter to cause control of the first GFM inverter based on the corresponding first GFM inverter voltage setpoints and the corresponding first GFM inverter frequency setpoints,
iteratively provide the corresponding second GFM inverter voltage setpoint and the corresponding second GFM inverter frequency setpoint to the second GFM inverter to cause control of the second GFM inverter based on the corresponding second GFM inverter voltage setpoints and the corresponding second GFM inverter frequency setpoints,
wherein the corresponding first GFM inverter frequency setpoints, provided to cause control of the first GFM inverter, at least partially differ from the corresponding second GFM inverter frequency setpoints provided to cause control of the second GFM inverter, and
iteratively provide the corresponding real power setpoints and corresponding reactive power setpoints to the grid-following resources.

23. The system of claim 22, wherein the one or more processors include one or more parent processors of a parent controller, one or more first child processors of a first child controller, and one or more second child processors of a second child controller.
